(19) United States
(12) Patent Application Publication
(10) Pub. No.: US 2009/0078814 A1
(43) Pub. Date: Mar. 26, 2009

(54) Web Inspection and Repair Machine with Rotary Razor Slitting

(76) Inventor: Allan R. Prittie, Toronto (CA)

Correspondence Address: SIM & MCBURNEY, 330 UNIVERSITY AVENUE, 6TH FLOOR, TORONTO, ON, M5G 1R7, CA

(21) Appl. No.: 12/236,885

(22) Filed: Sep. 24, 2008

Related U.S. Application Data
(60) Provisional application No. 60/974,586, filed on Sep. 24, 2007.

(51) Int. Cl. B26D 1/14; B65H 35/02; B26D 5/20

(52) U.S. Cl. 242/525; 83/13; 83/156

(57) ABSTRACT

A web processing machine permits slitting of a wide range of highly extensible materials with low Young's modulus of elasticity characteristics. The slitting function may be carried out under low elongating tensions while yielding highly accurate and repeatable width dimensions in the finished product. The machine incorporates a resiliently coated cylinder with extremely sharp and narrow rotating blades which are commonly adjusted into close contact with the coated cylinder. The blades are driven so that their peripheries slightly over-speed the web as it enters the first contact point of the coated cylinder and the blades as they rotate.

### FIELD OF INVENTION

This invention relates generally to web inspection and converting machines which are adapted to perform various process steps on an elongate web. The machine typically has an unwind mandrel and a rewind mandrel. The web is provided initially in the form of a coil or roll of web material which can be fitted onto the unwind mandrel. The web is then strung through various possible combinations of devices, such as idler rollers, error detectors, splicers, diecutters, printheads, graphics imaging systems, web slitters and sheeters. Slitting the web may be required for a lateral separation of printed and/or converted images when two or more images are located across the web. Inspection of the moving web can be done electronically or visually with the assistance of a stroboscope, or vision or video system that sequentially samples the images on the moving web. The present invention specifically relates to a means and an apparatus for slitting a web of material into a multiplicity of webs.

### BACKGROUND TO THE INVENTION

In conventional web processing systems, it is often required to slit the web being processed into a multiplicity of webs and to subsequently rewind each of those pre-slit webs onto individual cores which have been pre-locked onto the rewind shaft or rewind shafts in proper lateral alignment in readiness to receive each of those pre-slit webs onto one core per web.

It is also often required in conventional web processing systems to slit the web being processed into a multiplicity of webs, then to cross cut each of these webs into sheets, and then to deliver them one above the other in counted stacks or one overlapping the last in counted streams.

In order to accomplish the lateral severing or slitting of the advancing web it is often required that two, three and sometimes even four different slitting systems and methods be available to the operator in order to cope with the variety of materials needing to be slit. The particular slitting system chosen by the operator also is strongly dependent upon the level of the initial and the subsequent continuously variable longitudinal web processing tensions which are required by different materials as they proceed toward, and are wound upon, the individual cores.

There have historically been three major slitting methods and means employed in web processing system designs. This is true when slitting of thin materials with a very low Young's modulus such as polypropylene which is sometimes down to 10μ thick. It is also true as the materials increase through the Young's modulus range and even up to thicknesses of approximately 5 mm in the slitting of hot-rolled strip steel. These methods and means are generally referred to as:

1.0 Rotary shear-cut, or Rotary scissor-cut.

2.0 Rotary score-cut, or Rotary pressure-cut.

3.0 Razor-cut.

Within each of these three categories there is a number of submethods and submeans which are employed to meet very specific process demands and manufacturing targets. In order to meet a specific demands and targets required of the slitting procedure within the operation of the complete web processing system, the methods and means employed for slitting must often be severely restricted in order to perform properly on very few, and sometimes only one, web material. Such restrictions can render the complete machine as useless for the processing of any other material.

An example of a web processing machine which has been historically used in the printing industry is described in my U.S. Pat. No. 3,733,230, the disclosure of which is incorporated herein by reference. While the webflow path and the various slitting assemblies incorporated into this machine design had been used in many thousands of machines, this design suffers from drawbacks with respect to the manufacturing and processing demands of industry today.

A second example of the web processing machine is described in my U.S. patent application Ser. No. 11/703,090, the disclosure of which is also incorporated herein by reference. The slitting section of this machine has been designed with the flexibility to accommodate each of the three generally conventional major methods and means mentioned in paragraph [0005] above. However, each of these three exhibits very serious limitations when the machine is required to process highly elastic thin-films and pressure sensitive label carrier webs and to accurately slit and rewind them using web tensions in the order of 0.15 to 0.5 pounds force per linear inch of width.

The specific targets of the slitting method and means of the present invention herein described are to:

1.0 Allow a web processing system to process a much wider range of materials through one slitting system than has been historically possible in day-to-day production. The specific target range of this development starts at 10μ thick low density polyethylenes with a typical modulus of from 10 to 25 KSI and extends upwardly to approximately 80μ thick silicone coated pressure sensitive label carrier webs with a typical modulus of up to approximately 600 KSI.

2.0 Provide dramatically reduced slitting system setup times that have historically not been achievable in practice when processing thin-films. Short production runs can then be produced economically.

3.0 Increase the running life of each slitting assembly. The three commonly used slitting systems mentioned in paragraph [0005] all exhibit blade-to-blade and/or blade-to-material constant mechanical interference and therefore require frequent knife edge regrinding and knife replacement. As the sharp knife edges degrade during production runs because of this interference the web edge slitting quality also rapidly degrades.

4.0 Reduce the ecological impact of waste generation and improve the material yield on every job that requires the removal of lateral inter-web waste “gutter” strips.

5.0 Improve the individual web slit-width dimensional accuracy. The purpose of this target is to allow the printed graphics which are carried on each individual web to be more uniformly placed on the products to which these individual webs or labels are ultimately adhered.

6.0 Allow ergonomic retraction of the slitting system from the web processing machine, during a stop in the production run, in order to perform inspection of the slitting assemblies and maintenance thereof—while the machine is left under full web tensions, thus avoiding damage to the individual slit web section that is within the slitting zone during the knife inspection operation, and also avoiding the associated product loss the damage otherwise entails.

7.0 Provide a cost effective and process effective web tractioning method and means, specifically located in immediate proximity to the point at which the individual webs are severed. Through the use of this tractioning method and means, the present invention allows the application of process beneficial, uncommonly low web tension downstream of the slitting. The operator can choose to apply the very low individual longitudinal web tensions which are highly desirable when he or she is processing delicate extensible materials-knowing that the slit web dimensional tolerances and lateral graphics image positioning will not be degraded due to the low process tensions being used.

FIGS. 3, 4, 5, 6, 7, 8, and 9 depict slitting assemblies which are of Rotary Shear-Cut type. FIGS. 10, 11, and 12 depict slitting assemblies which are of Rotary Score-Cut type. FIGS. 13, 14, and 15 depict slitting assemblies which are of Razor-Cut type. All exhibit major weaknesses when they are employed to slit thin-films and typical pressure sensitive label carrier webs and then to have the resultant multiplicity of webs transferred toward the rewind system or sheet cut off system of the web processing machine.

### SUMMARY OF INVENTION

With reference to paragraph [0008], the present development relates to a way in which to address and solve the main drawbacks of the three conventional slitting system configurations and constructions. The present development also relates to a way in which to separate the effects of the process requirements of a slitting function from the elongating tensioning requirements of a material when it is next being transported downstream at extremely low elongating tension.

In view of the shortcomings of the prior art and the targets for the present development, as set forth in paragraph [0008], it is an object of this invention to pass a single elongate web through a multi-web slitting procedure using a way in which to allow each of those improvements targeted in paragraph [0008] to be achieved while also allowing the downstream processing of the resultant webs at very low elongating tensions. Essentially, the present development allows the dimensional and other quality requirements of the slitting procedure to be process “decoupled” from the downstream material tensioning constraints and requirements as the resultant webs emanate from the slitting zone and continue traveling toward the next processing station which may be a rewinding or sheeting zone of the web processing system.

In accordance with one aspect of the present invention, there is provided for use in a web processing system, a module providing for the longitudinal severing or slitting of a single elongate web into a multiplicity of webs and/or rewound rolls, each web flowing at controlled, laterally balanced web strain, the module comprising:
1.1 a mounting frame,
1.2 means to constrain the flow of a single elongate web through the mounting frame,
1.3 one or more blades which are thinly longitudinally sectioned and whose outside diameters are substantially cylindrically sharp,
1.4 blade mounting assemblies which locate and lock the blades at desired lateral positions with respect to the single elongate web,
1.5 means to allow the locked blade assemblies to rotate either about a common axis or about individual axes,
1.6 first control means to effect the rotation of the blades at controlled surface speeds when required,
1.7 first structural means to locate the blade mounting assemblies such that they are always substantially parallel, in two planes, to the flow path of the single elongate web,
1.8 a resiliently surfaced cylinder or cylinders,
1.9 second structural means to locate this cylinder or these cylinders as to be always substantially parallel, in two planes, to the flow path of the single elongate web,
1.10 second control means to effect the rotation of the resiliently surfaced cylinder at controlled surface speed when required, and
1.11 locating assemblies which provide adjustable separation positioning for the first structural means with respect to the second structural means, such that the blade surfaces can be adjustably urged against the resiliently surfaced cylinder to effect severing or slitting of a web as it is constrained to flow between the first structural means and the second structural means.

Thus, the present invention, in one embodiment, involves the incorporation of a resiliently coated cylinder or “soft rotating anvil” in conjunction with extremely sharp and very narrow “rotating razor blades”. The blades are commonly adjusted into close contact with the anvil and can actually be adjusted to indent the anvil when necessary. The blades are driven such that their outer cutting peripheries slightly over-speed the web as it enters the first contact point of the anvil and the blades as they rotate. These design principles allow the achievement of the stated objectives outlined in paragraph [0008]

1. The web is fully supported exactly at the point in time at which it is being slit into a multiplicity of webs. This design approach allows a much wider range of materials encompassing those filmic and coated laminates with a Young's modulus as low as 10 KSI and up to 600 KSI to be processed.

2. Since all of the rotating blades can be commonly and quickly disengaged from the soft anvil, and since the anvil can easily slide laterally on the web, the complete slitting assembly can be quickly or retracted out into the operating aisleway for set up. Then, there is only one blade per slit to be adjusted. Since the present invention allows these design points to be incorporated, there is a dramatic reduction in make ready and change over time thus allowing the production of short runs economically.

3. The incorporation of a soft rotating anvil to support the web against the blades allows the hardness of the blades to be dramatically increased (without major consideration of blade tip high brittleness). Since there is no metal-to-metal interference to accomplish the slitting function there is extremely low blade wear. This combination allows dramatic improvement in blade life over that of systems incorporating either Rotary Shear-cut or Rotary Score-cut slitting. Since the rotating razor blades move continually with respect to the web there is an avoidance of the localised wear and very low blade life that fixed Razor blade cutting systems exhibit.

4. The present invention in this first embodiment, with its use of a resilient rotating anvil to support the complete width of the web and which therefore allows the rotating razor blades to be much more closely placed laterally, allows the production of jobs with much narrower waste side trims. Very often it is required by the printed graphics of a job to incorporate lateral inter-web waste “gutters” which must be removed and discarded as the job is being slit. The historic methods of slitting gutters typically requires a gutter width of up to ½″ in order to accommodate the knife minimum separations available and to minimise the chances of having the gutter trims from becoming drawn into and jamming in the blade assemblies. The present invention allows the width of gutter trims to the order of ¼″ and sometimes even narrower. One of the advantages yielded by this invention when gutters are required is 7-10% reduction in waste. The cost of material as a percentage of selling price of a job often approaches 60%.

5. The complete lateral support of the web afforded by the resilient coating on the soft anvil allows a very cost effective way of supporting the web in order to achieve improved web slit-width dimensional accuracy. Historically, in order to reach the standard of slit-width tolerances afforded through the use of the present invention, very costly ground separator rings have had to be utilised. Associated with the cost of the rings there is a long setup time involved and often the rings can only be used for one series of widths. So, much improved dimensional accuracy and virtually zero specific job tooling cost have been achieved with the present invention.

6. Localised traction is applied to the web as it passes toward and into the slitting section. This is as a result of the interaction between the soft anvil and the knives of the present invention. The target and purpose of this approach was to allow highly elastic materials to be slit to high lateral dimensional accuracy without requiring the application of high elongating tension in order to stabilise the lateral tracking the web. In fact the present invention in this first aspect allows the web be accurately slit while needing virtually no rewinding tension. The practical advantage of this attribute is that high lateral slitting accuracy can actually be achieved with very low downstream tensions so there is effectively a “decoupling” of the two. Therefore, the operator can select the desired downstream tension to suit the elongation constraints of the material itself and the rewind roll hardness desired.

Accordingly, one embodiment of the present invention provides a web processing machine allowing inspection and repair of a roll of web material, the machine including:

1. an unwind mandrel

2. a rewind mandrel

3. an inspection zone

4. a splicing area

5. a web draw/nip assembly

6. a web slitting system

7. guide rolls for directing the web along the path from the unwind mandrel, past the inspection zone, downstream to the splicing area, downstream through the web draw/nip, through the slitting zone, to the rewind mandrel, and

8. first control means for causing the web to move past said inspection zone and said splicing area, through said web draw/nip assembly; the improvement which comprises providing said machine with said web slitting system including:

9. a slitting system support structure, laterally retractably mounted to the frame of said machine

10. means to move the support structure laterally from the operating position within the web processing machine out into the operating aisleway in front of said machine.

11. a web slitting assembly consisting of two substantially parallel shafts whose separation can be adjusted while maintaining parallelism, said shafts being constrained for identical and counter-rotational angular speed, such speed being synchronized with and proportional to the transport speed of said web processing machine, a resilient sleeve mounted to one of said shafts, a plurality of rotary razor blades securely mounted to laterally adjustable blade holders, said blade holders being releaseably locked to the second said shaft, said shafts' separation being adjusted such that the blades can be variably indented into the surface of said resilient sleeve in order to allow said blades and said resilient sleeve to cooperate to longitudinally sever said web when said web processing machine is in motion,

12. an idler roll mounted to said web processing machine support structure and downstream of said slitting assembly such that said web, after it leaves said draw/nip assembly, is constrained to pass substantially tangentially directly through said slitting system with a web pass line that does not attempt to provide web wrap around either the cutting peripheries of said blades or the periphery of said resilient sleeve.

In one embodiment of the present invention, one or more means may be provided between the unwind mandrel and the rewind mandrel or sheeting system to effect one or more converting processes or functions, such as automatic splicing, diecutting, contact printing, noncontact printing, direct electronic imaging and indirect electronic imaging.

The present invention provides, in another aspect, in a web processing system, a method of severing or slitting a single elongate web into a multiplicity of webs and/or rewound rolls, each web flowing at controlled, laterally balanced web strain whereby:
4.1 a module which is integrated into a mounting frame is provided for inclusion into the web processing system,
4.2 the side-elevational webflow of the single elongate web through the mounting frame is constrained to be accurately presented to the longitudinal severing or slitting module,
4.3 one or more thin section slitting blades which have been sharply ground on their outside diameters are used to slit the web,
4.4 these slitting blades are then attached to blade mounting assemblies which can be then located at desirable lateral positions with respect to the single elongate web as it passes through the module,
4.5 the blade mounting assemblies are then locked to a rotatable cylinder or rotatable cylinders,
4.6 using first control means the blades are rotated under power at suitable surface speeds with respect to the speed of the single elongate web as it passes through the module,
4.7 second control means are used when desired to rotatably drive a resiliently surfaced cylinder or cylinders upon which the single elongate web has been constrained,
4.8 the separation of the blades and resiliently coated cylinder are adjusted such that the blades are brought into urged contact with the single elongate web to effect severing or slitting of the web as it passes through the module.

This invention, in a further embodiment provides a method of slitting a roll of web material, for use with a machine which incorporates: an unwind mandrel; a rewind mandrel; an inspection zone; a splicing area; a web draw/nip assembly; a slitting system support structure laterally retractably mounted to the frame of said machine; a method to move the support structure laterally from the operating position within the web processing machine out into the operating aisleway in front of said machine; a web slitting assembly consisting of two substantially parallel shafts whose separation can be adjusted while maintaining parallelism, said shafts being constrained for identical and counter-rotational angular speed, such speed being synchronized with and proportional to the transport speed of said web processing machine, a resilient sleeve mounted to one of said shafts, a plurality of rotary razor blades securely mounted to laterally adjustable blade holders, said blade holders being releaseably locked to the second said shaft, said shafts' separation being adjusted such that the blades can be variably indented into the surface of said resilient sleeve in order to allow said blades and said resilient sleeve to cooperate to longitudinally sever said web when said web processing machine is in motion; and a plurality of idler rollers mounted to said machine, the method including the steps of:

1. stringing the web material from the unwind roll, through the inspection zone, around a plurality of idler rollers in substantially boustrophedonic configuration, through the splicing area, through the web draw/nip assembly, through the slitting zone; and eventually to the rewind mandrel or sheeting station.

2. retracting the slitting system support structure laterally from the normal operating position within the web processing machine and out into the operating aisleway in front of said machine;

3. sliding, laterally positioning, and locking the resilient anvil sleeve onto one of the two substantially parallel shafts whose separation can be adjusted;

4. laterally positioning the individual rotary razor blades and locking their respective blade holders to the second shaft, each holder being locked laterally to put its respective knife into proper lateral slitting position in order to match the graphics layout of the job to be run;

5. adjusting the separation of the two shafts such that the rotary razor blades' cutting peripheries are variably indenting the sleeve;

6. increasing the separation of the two shafts such that the blades and sleeve of the just opened shafts can clear the web which has been threaded through from the draw system to the plurality of rollers just prior to the rewind mandrel;

7. reinserting the slitting system support structure into its proper lateral position within the slitting zone;

8. applying proper tensions to the web material in the various tension zones of the machine;

9. reducing the separation of the two shafts such that the web is just being severed by the action of the razor blades passing through the material and indenting the sleeve; jogging the web forward in the machine, laterally positioning the proper width cores under the individual pre-slit webs which have come from the slitting assembly, and taping the pre-slit webs to their respective cores.

Following this setup procedure, the job can be put into production at normal operating speeds for inspection, slitting, and rewinding.

In another embodiment of the present invention, one or more stations may be provided between the unwind mandrel and the rewind mandrel or sheeting system to effect one or more converting processes or functions, such as automatic splicing, diecutting, contact printing, noncontact printing, direct electronic imaging and indirect electronic imaging.

In another embodiment of the present invention, the web being slit may be prewrapped and/or postwrapped around the resilient anvil as it passes through the particular production machine.

In another embodiment of the present invention the rewinding roll itself acts as a “resilient anvil”. In this embodiment the outer diameters of the rotary razor blades come in contact with, are urged against, and slightly indent the rewinding roll to effect the slitting function. This application of the present invention provides highly accurate lateral wrap-to-wrap buildup as the rewind roll increases in diameter during production.

### BRIEF DESCRIPTION OF DRAWINGS

FIG. 1 is a schematic side-elevational view of a web inspection and repair machine which includes a slitting assembly provided in accordance with one embodiment of the invention.

FIG. 2 is an enlarged schematic side-elevational view of detail A shown in FIG. 1. This describes the proceeding path of the web as it passes from the web draw/nip assembly through the slitting zone and toward the rewind shaft or sheeting station.

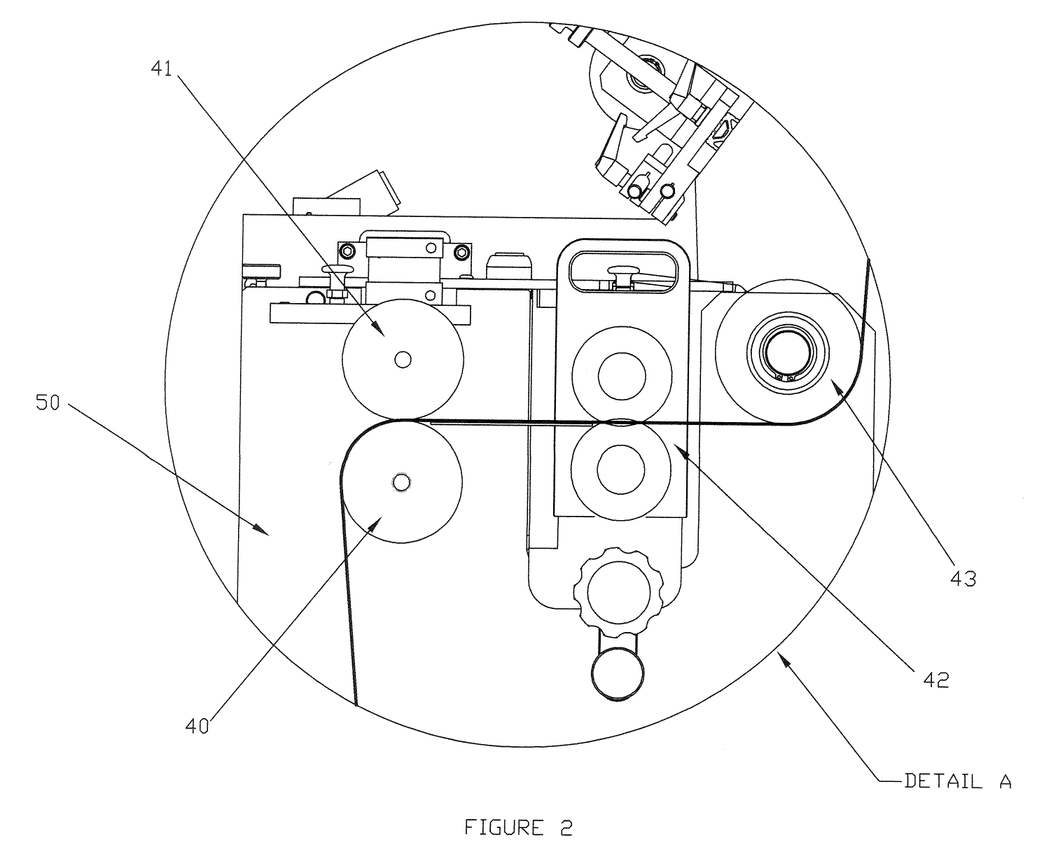

FIG. 3 is a schematic isometric view of a conventional Rotary Shear-cut slitting assembly which is mounted to a retractable slitting system support structure.

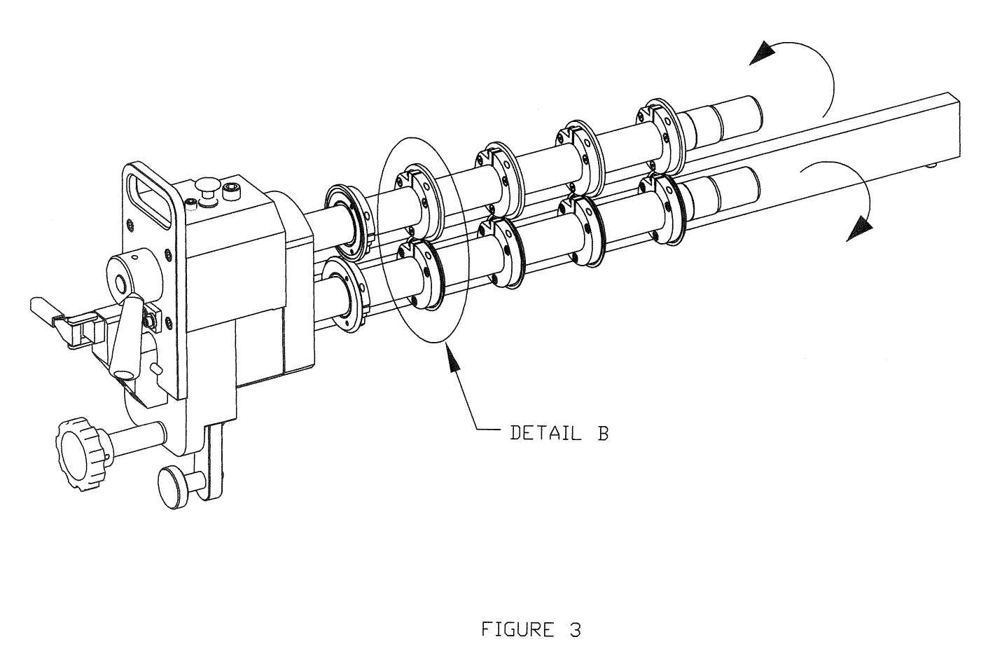

FIG. 4 is an enlarged schematic isometric view of detail B shown in FIG. 3.

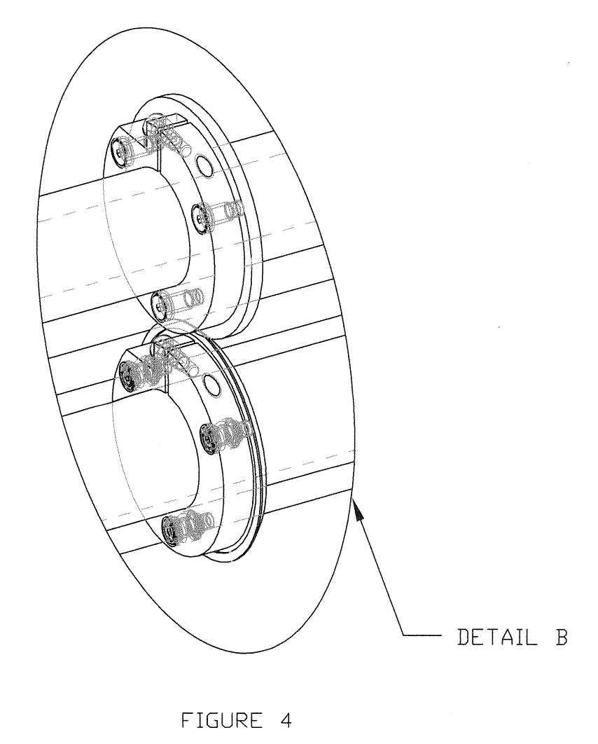

FIG. 5 is a schematic end-elevational view of a conventional Rotary Shear-cut slitting assembly which shows the web material proceeding toward the viewer.

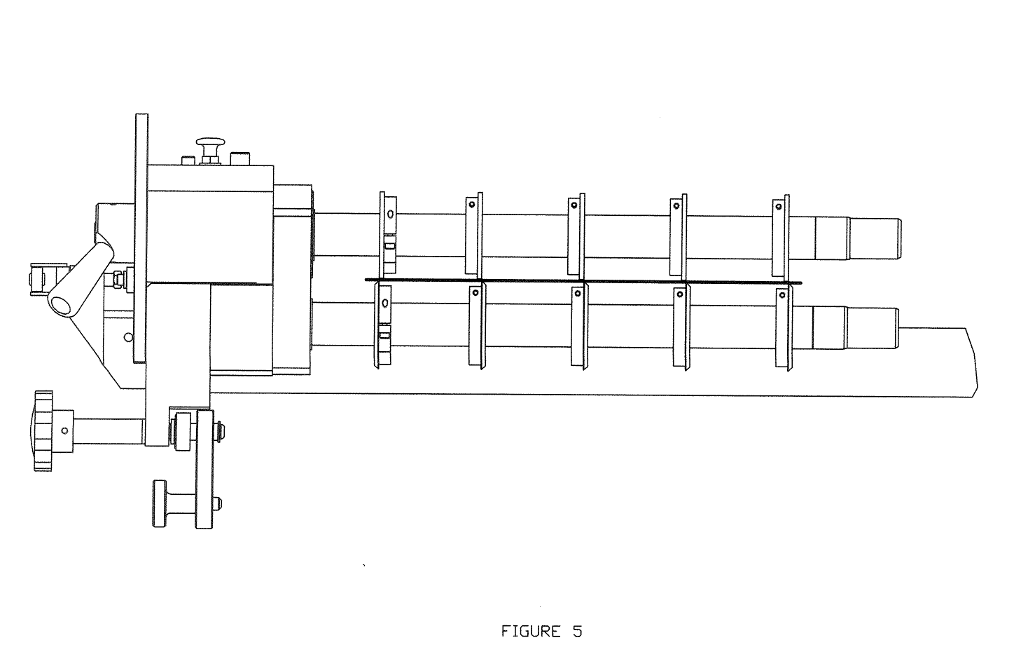

FIG. 6 is a truncated schematic end-elevational view of a conventional Rotary Shear-cut slitting assembly.

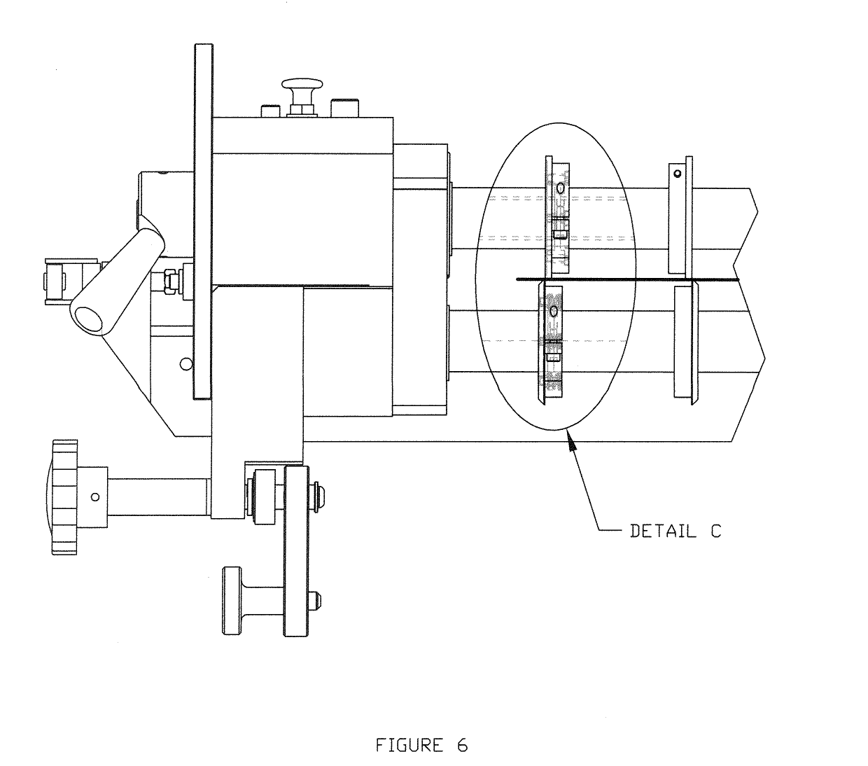

FIG. 7 is an enlarged view of detail C of FIG. 6.

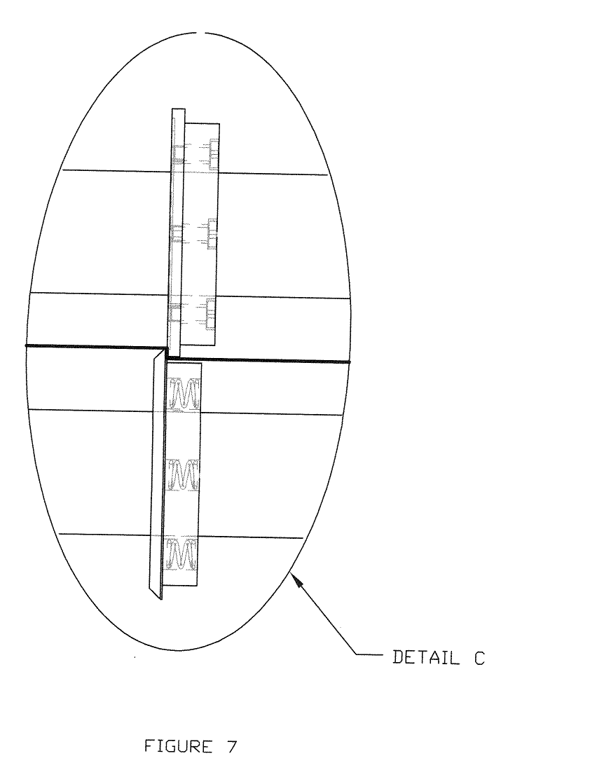

FIG. 8 is a schematic end-elevational view of a conventional Rotary Shear-cut slitting assembly which has been set up to slit lateral gutter waste from between four images across the web and set up to remove side trim at the front and back edge of the web.

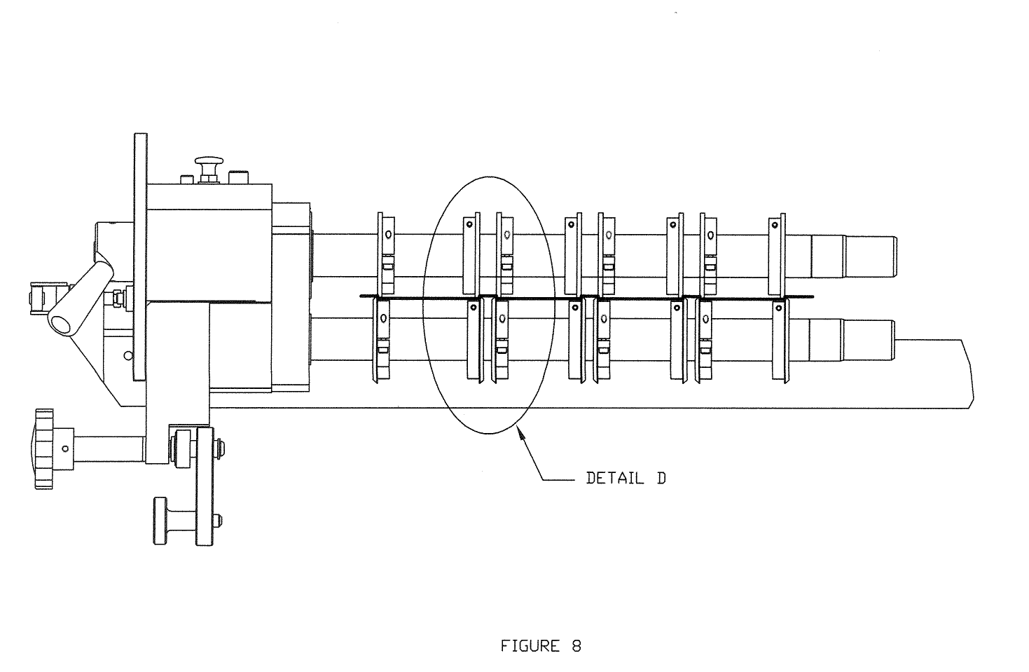

FIG. 9 is an enlarged view of detail D of FIG. 8.

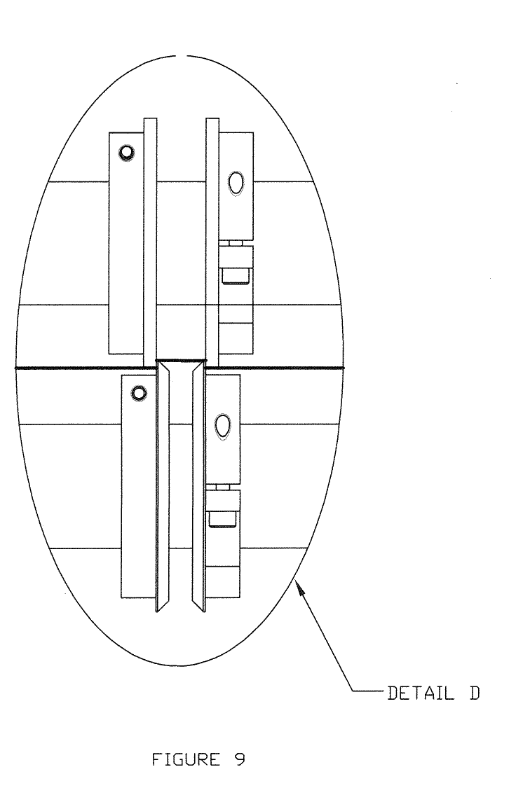

FIG. 10 is a schematic isometric view of a conventional Rotary Score-cut slitting assembly which cutting against an hardened draw roll within a web processing machine.

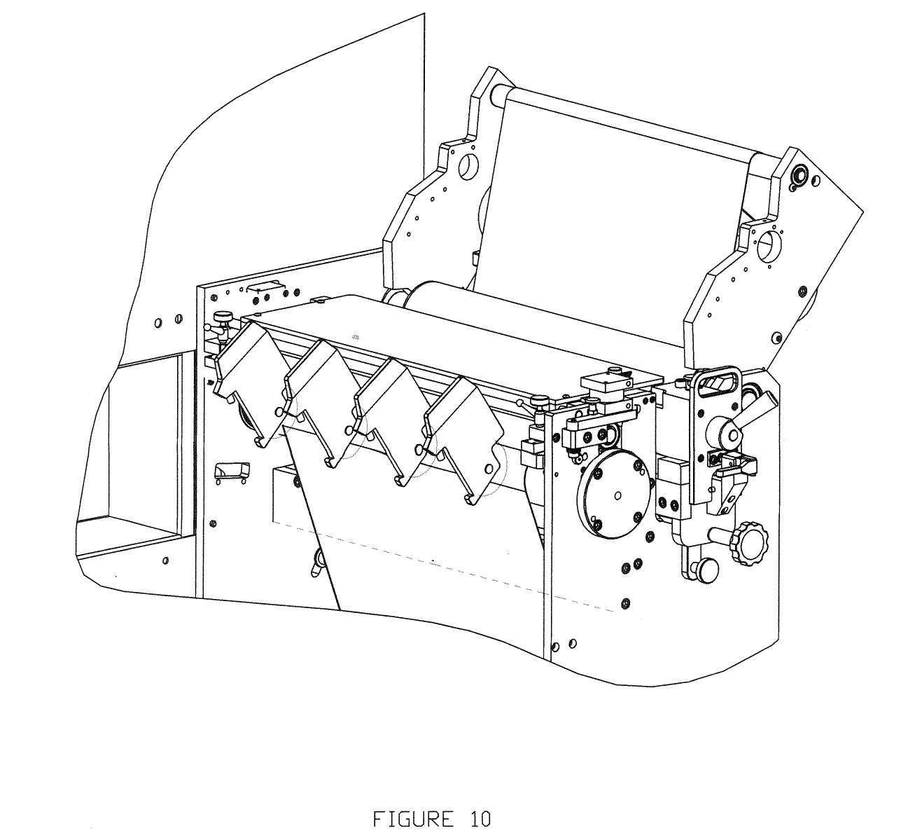

FIG. 11 is a schematic end-elevational view of a conventional Rotary Score-cut slitting assembly showing the web firstly being pressure-cut against a hardened draw roll and then the slit webs proceeding through the draw roll and toward a rewind system or sheeting system.

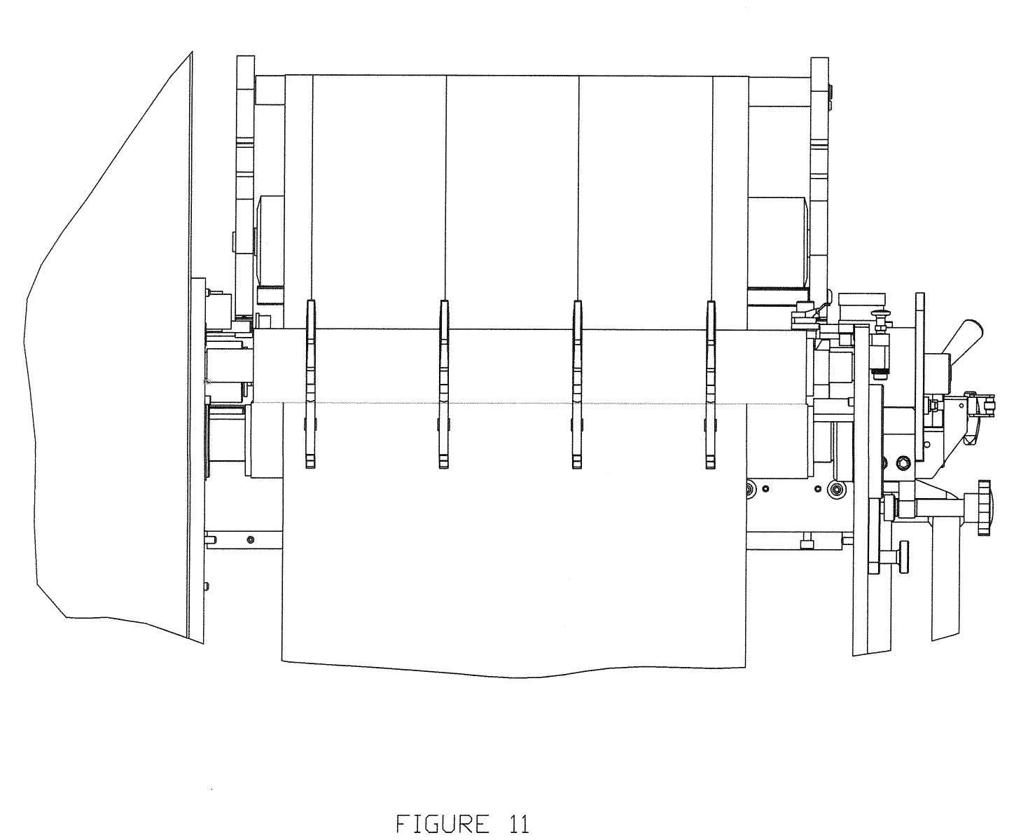

FIG. 12 is a schematic cut away view of a conventional Rotary Score-cut slitting assembly.

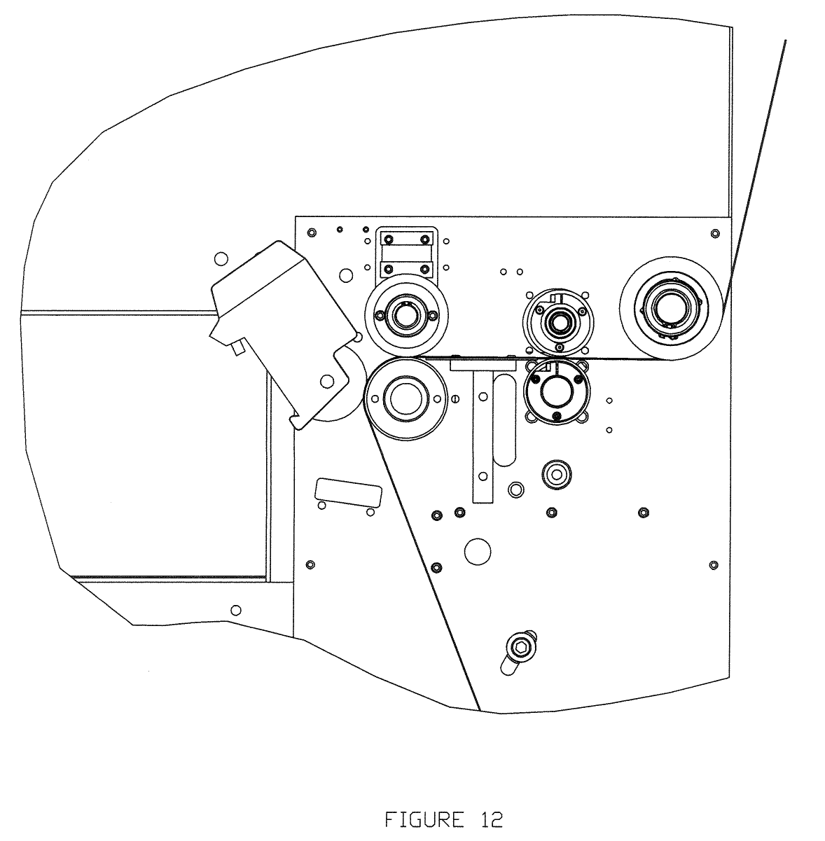

FIG. 13 is a schematic isometric view of a conventional Razor-cut slitting assembly.

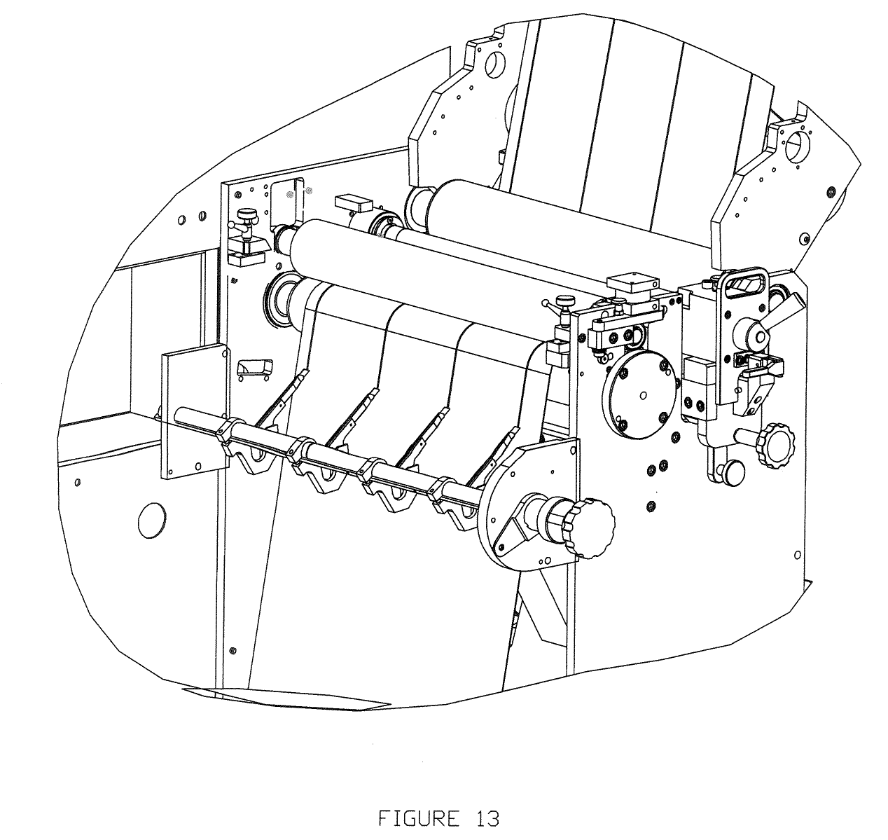

FIG. 14 is an end-elevational view of a conventional Razor-cut slitting assembly which shows the razors severing the web just before the draw/nip assembly and then showing the severed webs proceeding toward a rewind system or a sheeting system.

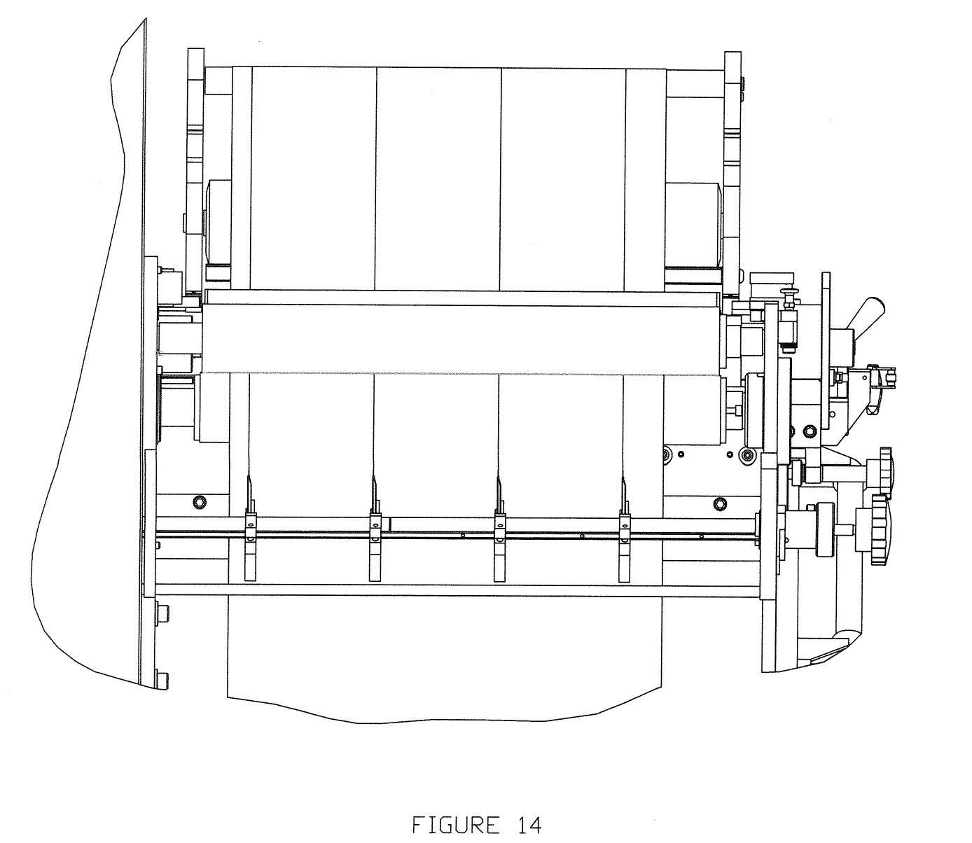

FIG. 15 is a side-elevational view of a conventional Razor-cut slitting assembly.

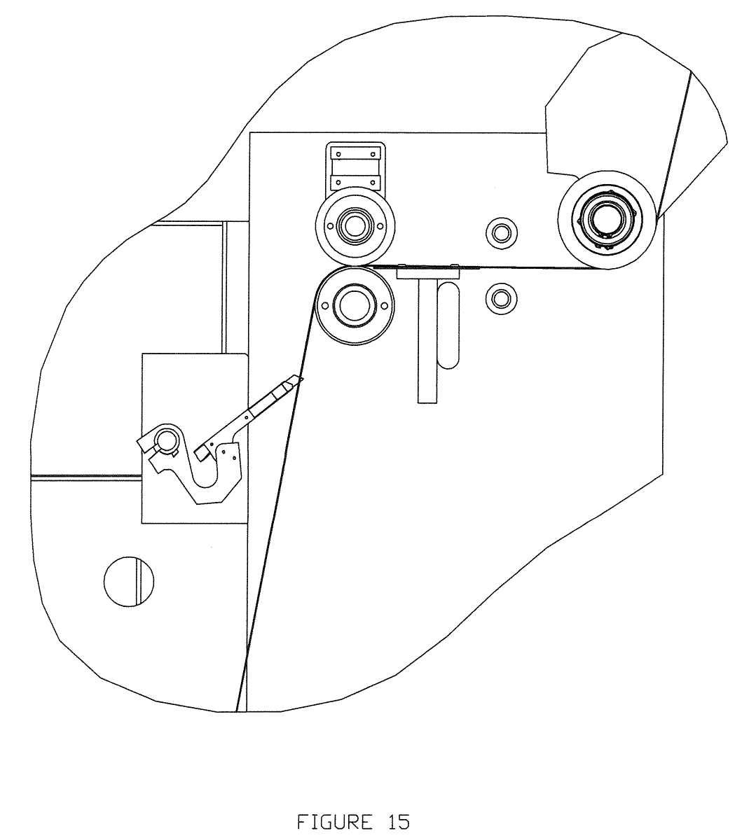

FIG. 16 is a schematic isometric view of a Rotary Razor-Cut slitting assembly describing one embodiment of the present invention.

FIG. 17 is an enlarged schematic isometric view of detail E of FIG. 16.

FIG. 18 is an end-elevational view of a Rotary Razor-cut slitting assembly describing one embodiment of the present invention.

FIG. 19 is a truncated and-elevational view of a Rotary Razor-cut slitting assembly showing dual blade holders equipped to slit very narrow gutter trims and is part of an assembly describing one embodiment of the present invention.

### DESCRIPTION OF PREFERRED EMBODIMENT

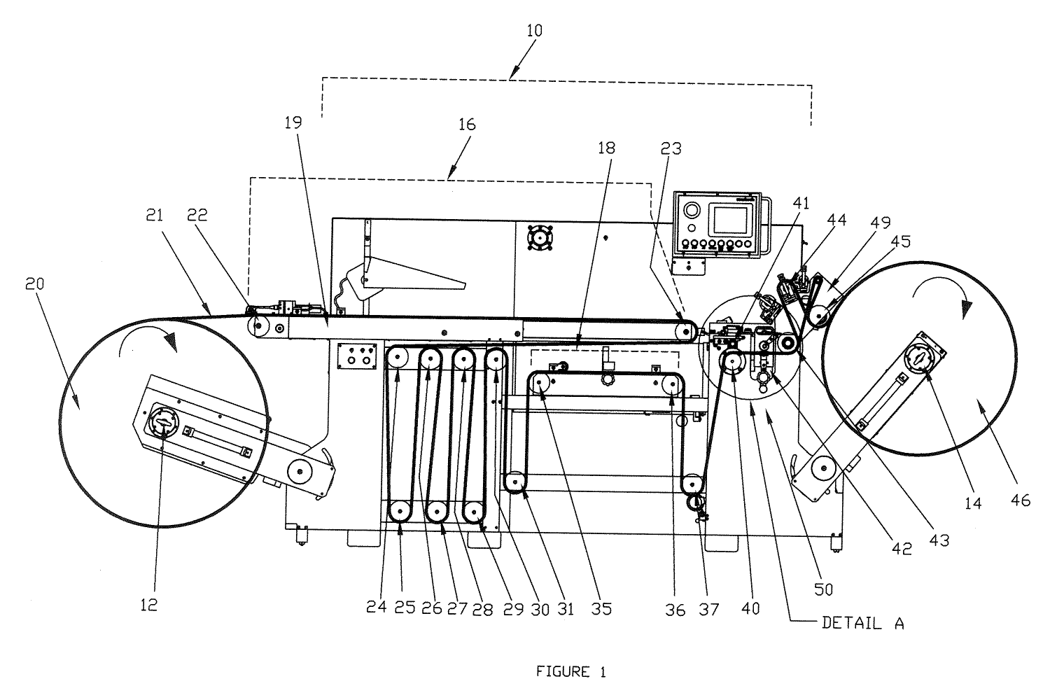

Attention is first directed to FIG. 1, which is a schematic side-elevational view showing the major components of a web processing mechanism to which one embodiment the present invention has been applied.

The mechanisms shown generally at 10 in FIG. 1 includes an unwind mandrel 12, a rewind mandrel 14, an inspection zone 16, and a splicing area 18.

A coil 20 of web material is mounted on the unwind mandrel 12, with the web 21 being paid off the coil 20. The web 21 is next threaded sequentially around rollers 22 and 23. The inspection zone 16 extends generally between rollers 22 and 23.

The web 21 exiting the inspection zone support structure is sequentially entrained around fixed idler rolls 24, 25, 26, 27, 28, 29, 30, and 31. Web 21 is next entrained around either rolls 35 and 36. The splicing area 18 extends generally between rolls 35 and 36. The web 21 is entrained around an idler roll 37 and then around a draw roll 40 and between the draw roll 40 and a nip roll 41. The combination of draw roll 40 and nip roll 41 can be driven by a main motive power means (not illustrated for the machine 10) to traction the web so that it can be transferred from the unwind mandrel 12 to the rewind mandrel 14.

The web next enters a slitting mechanism 42 and is entrained around stationary idler roll 43 and then sequentially around idler rolls. The latter two idler rolls 44 and 45 are mounted at one end of a lever arm assembly 49 which is pivoted at the other end to a portion of the frame 50. This arrangement allows the idler rolls 44 and 45 to follow the gradually increasing diameter of the rewind coil 46, ensuring that the web is rewound with proper parallelism and tightness.

In the normal use of the machine shown in FIG. 1, the operator stands or sits at the inspection zone 16 and uses conventional control means for causing the web 21 in coil 20 to flow along the path illustrated in FIG. 1 from the coil 22 the rewind coil 46, which includes moving the web 21 past the inspection zone 16 in the splicing area 18. When the operator detects a flaw, he activates a conventional braking means (not illustrated in FIG. 1) to bring the velocity of the web down to a very low “creep” or “jog” speed. The operator then advances the detected web flaw to the splicing area and brakes the web to a standstill in order to make a fault repair.

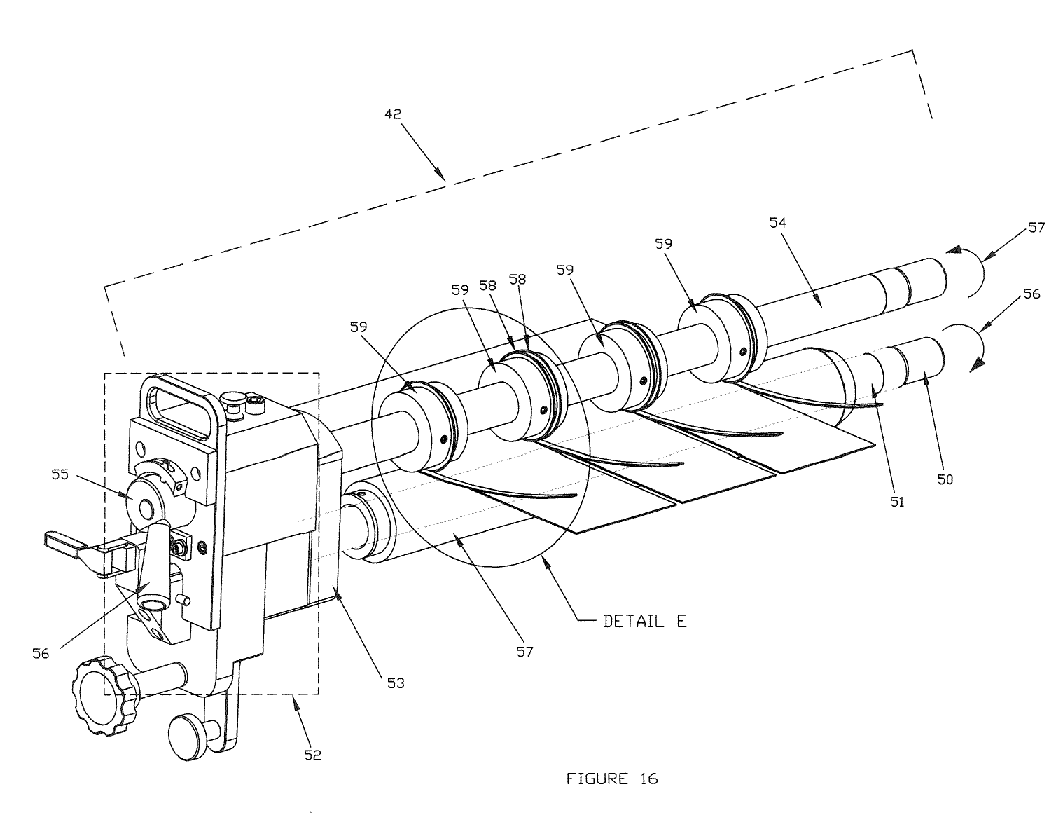

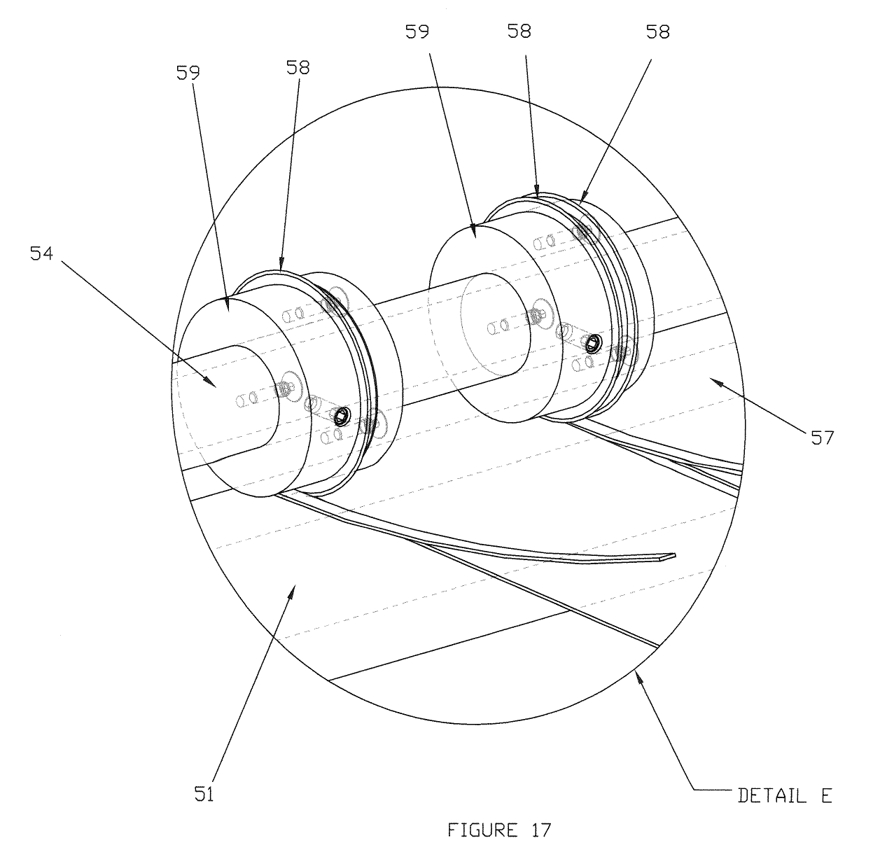

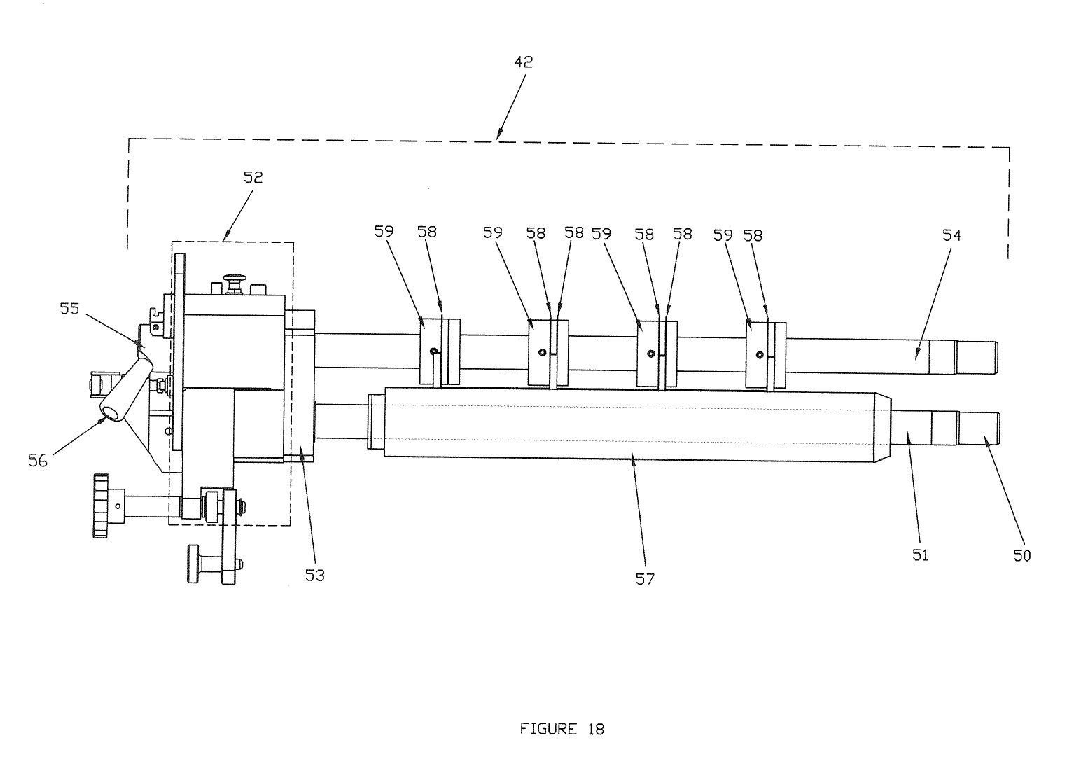

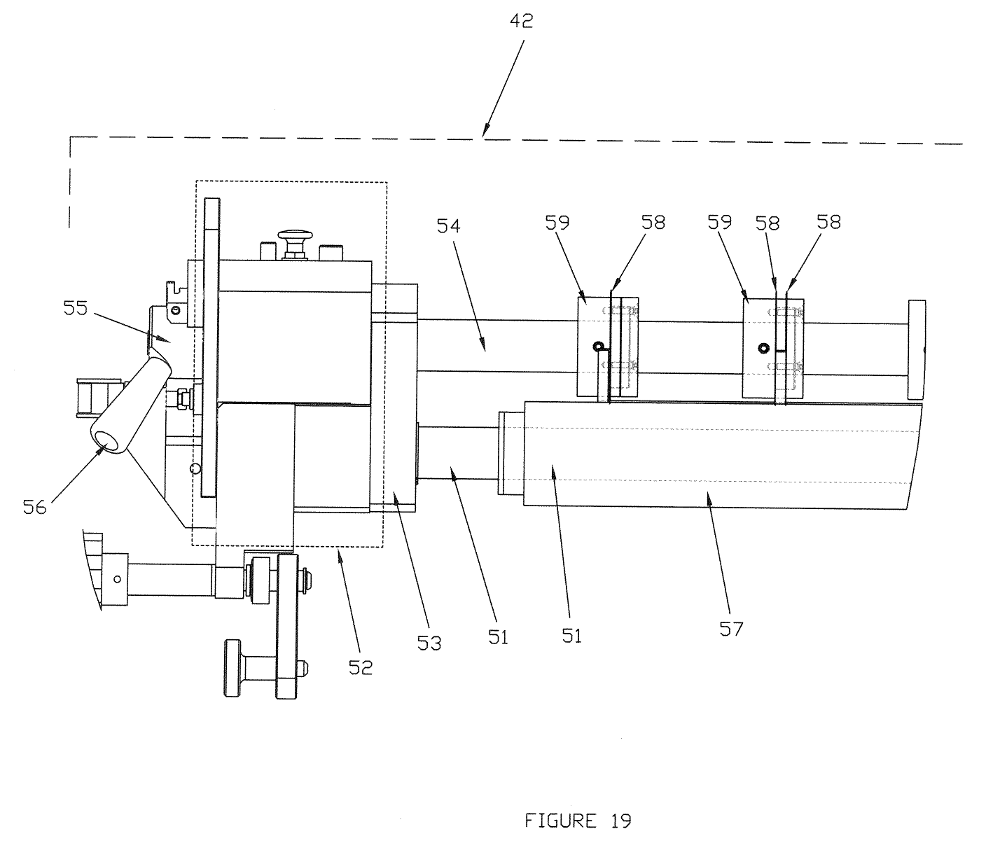

Attention is next drawn to FIGS. 16, 17, 18, and 19. The slitting assembly 42, which is an embodiment of the present invention, is represented in FIG. 16, FIG. 18, and in truncated version in FIG. 19.

In this particular embodiment, it is the lower slitter shaft 51 as shown in FIGS. 18 and 19 which is driven by rotational motive means (not shown in these figures). When the upper slitter shaft 54 is inserted into proper running position and becomes part of slitter mechanism 42 within the machine 10 the rotational motive means engages section 50 of lower shaft 51. When the operator starts the machine, lower shaft 51 is driven synchronously with and proportional to the web flow which is governed by the main drive means (not shown in these figures) of machine 10.

With reference to FIG. 1, the web processing mechanism 10, to which the present invention has been applied, has a webflow which is moving from left to right. Therefore in this embodiment the lower shaft 50 of the slitting assembly 42 will be rotated under power in clockwise fashion as viewed from the operator side of the machine and as is represented by the directional arrow 56 in FIG. 16.

Lower shaft 51 in turn is equipped with rotary power transfer means (not shown in FIGS. 16, 17, 18 and 19) but which are located within guard 53. Guard 53 forms a part of slitter front support assembly 52 which houses all front rigidisation bearings (not shown) for the lower shaft 51 and the upper shaft 54. Upper shaft 54 is then driven synchronously but with slightly different angular speed than lower shaft 51 and upper shaft 54 rotates counterclockwise, when the web machine 10 is moving in normal left-to-right processing direction.

A resiliently coated sleeve 57 is releasably locked to lower shaft 51. The coating is ground to be concentric with the inner diameter of the sleeve, so that the surface will run with reasonable concentricity.

Very thin annular rings 58 whose peripheries are carefully ground to a sharp point and which are also referred to as “rotary razor blades” 58 are mounted to laterally movable and lockable blade holders 59. The holders 59 are designed to clamp the rings 58 such that the peripheries of the rings 58 spin in close concentricity with respect to upper shaft 54.

Upper shaft 54 is rotationally located within an eccentric body 55 which is parallel to and exactly in line with, but offset from upper shaft 54. Through the angular operation of lever 56, which is attached to eccentric body 55, the upper shaft 54 can be made to move closer to or farther away from lower shaft 51.

Adjustable stops (not shown herein) govern the amount of rotation of eccentric 55 so that the operator can quickly adjust the amount of indentation of the rings 58 into the sleeve 57, that is to say, adjust the penetration of the blade tips so that the web 21 which passes over the sleeve 57 and which is to be severed by the engagement of rings 58 and sleeve 57 can be cleanly cut during high speed operation.

### SUMMARY OF DISCLOSURE

In summary of this disclosure, the present invention relates to a novel arrangement in a web and/or sheet processing system, for slitting a wide range of highly extensible materials with very low Young's modulus of elasticity characteristics. This invention also allows the slitting function to be carried out under extremely low elongating tensions while yielding highly accurate and repeatable width dimensions in the finished product. While one embodiment of the present invention has been illustrated in the accompanying drawings and described hereinabove, it will be evident to those skilled in the art that changes and modifications may be made therein without departing from the essence of the invention. Moreover, all components may be substituted with technically equivalent parts.

What is claimed is:

1. For use in a web processing system, a module providing for the longitudinal severing or slitting of a single elongate web into a multiplicity of webs and/or rewound rolls, each web flowing at controlled, laterally balanced web strain, the module comprising:
1.1 a mounting frame,
1.2 means to constrain the flow of a single elongate web through the mounting frame,
1.3 one or more blades which are thinly longitudinally sectioned and whose outside diameters are substantially cylindrically sharp,
1.4 blade mounting assemblies which locate and lock the blades at desired lateral positions with respect to the single elongate web,
1.5 means to allow the locked blade assemblies to rotate either about a common axis or about individual axes.
1.6 first control means to effect the rotation of the blades at controlled surface speeds when required,
1.7 first structural means to locate the blade mounting assemblies such that they are always substantially parallel, in two planes, to the flow path of the single elongate web,
1.8 a resiliently surfaced cylinder or cylinders,
1.9 second structural means to locate this cylinder or these cylinders as to be always substantially parallel, in two planes, to the flow path of the single elongate web,
1.10 second control means to effect the rotation of the resiliently surfaced cylinder at controlled surface speed when required, and
1.11 locating assemblies which provide adjustable separation positioning for the first structural means with respect to the second structural means, such that the blade surfaces can be adjustably urged against the resiliently surfaced cylinder to effect severing or slitting of a web as it is constrained to flow between the first structural means and the second structural means.

2. The module of claim 1 in which the web flow path is constrained to pre-wrap and/or post-wrap the resiliently surfaced cylinder relative to the angle at which the blades are urged against the resiliently coated cylinder.

3. The module of claim 1 in which the resiliently surfaced cylinder is replaced by the individual rewinding rolls.

4. In a web processing system, a method of severing or slitting a single elongate web into a multiplicity of webs and/or rewound rolls, each web flowing at controlled, laterally balanced web strain whereby:
4.1 a module which is integrated into a mounting frame is provided for inclusion into the web processing system,
4.2 the side-elevational webflow of the single elongate web through the mounting frame is constrained to be accurately presented to the longitudinal severing or slitting module,
4.3 one or more thin section slitting blades which have been sharply ground on their outside diameters are used to slit the web,
4.4 these slitting blades are then attached to blade mounting assemblies which can be then located at desirable lateral positions with respect to the single elongate web as it passes through the module,
4.5 the blade mounting assemblies are then locked to a rotatable cylinder or rotatable cylinders,
4.6 using first control means the blades are rotated under power at suitable surface speeds with respect to the speed of the single elongate web as it passes through the module,
4.7 second control means are used when desired to rotatably drive a resiliently surfaced cylinder or cylinders upon which the single elongate web has been constrained,
4.8 the separation of the blades and resiliently coated cylinder are adjusted such that the blades are brought into urged contact with the single elongate web to effect severing or slitting of the web as it passes through the module.

5. The method of claim 1 while further constraining the contact angle of the single elongate web and/or the emanating multiplicity of webs to pre-wrap and/or post-wrap relative to the angle at which the blades are urged against the resiliently surfaced cylinder about its periphery.

6. The method of claim 1 in which the individual rewinding rolls replace the resiliently surfaced cylinder and the blades sever or slit the web longitudinally as they are controllably urged against said rewinding rolls.
